(19) United States
(12) Patent Application Publication
(10) Pub. No.: US 2010/0238317 A1
(43) Pub. Date: Sep. 23, 2010

(54) WHITE BALANCE PROCESSING APPARATUS, METHOD FOR PROCESSING WHITE BALANCE, AND WHITE BALANCE PROCESSING PROGRAM

(75) Inventor: Yasushi Takeo, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/729,144

(22) Filed: Mar. 22, 2010

(30) Foreign Application Priority Data
Mar. 23, 2009 (JP) 2009-070664

(51) Int. Cl. H04N 9/73

(52) U.S. Cl. 348/223.1; 348/E09.051

(57) ABSTRACT

A white balance processing apparatus including: an image data obtaining unit for obtaining image data on the basis of a photographed image; a light source condition determination unit for determining a condition of a light source in imaging as an outdoor light source in the case where subject luminance of the image data is relatively high, while determining a condition of a light source in imaging as an indoor light source in the case where the subject luminance of the image data is relatively low; and a white balance adjustment unit for determining a color to be converted into an achromatic color on the basis of color information of a pixel in the image data to adjust white balance of the image data, the color to be converted being selected from colors including a more bluish color with respect to the case that the condition of the light source is determined as an outdoor light source in the case where the determined condition of the light source is an indoor light source.

### CROSS REFERENCES TO RELATED APPLICATIONS

The present invention contains subject matter related to Japanese Patent Application No. 2009-70664 filed in the Japanese Patent Office on Mar. 23, 2009, the entire contents of which are incorporated herein by reference.

### BACKGROUND

1. Technical Field

The present invention relates to a technique for adjusting white balance of image data on the basis of a photographed image.

2. Related Art

In an image input apparatus such as a digital still camera, raw image data (original image data) representing a photographed image is generated. Processing for adjusting white balance is performed on image data on the basis of such raw image data.

A method for controlling white balance, which is disclosed in JP-A-2007-306320, includes: dividing an image into a plurality of blocks; converting a color space coordinate representing a color signal of each of the divided blocks into a white balance determination space coordinate; setting a light source estimation area and a high-saturation determination area in the white balance determination space; estimating a kind of the light source on the basis of a white balance determination space coordinate distribution in the light source estimation area; determining a kind of the light source on the basis of the estimated kind of the light source and a white balance determination space coordinate distribution in the high-saturation determination area; and calculating control information of white balance on the basis of the determined kind of the light source.

However, a kind of the light source to be determined may not be suitable for a subject, and color reproducibility of an image may not be appropriate.

### SUMMARY

An advantage of some aspects of the invention is to improve color reproducibility of an image on the basis of a photographed image.

According to an aspect of the invention, image data on the basis of a photographed image is obtained, and then a condition of a light source in imaging is determined on the basis of subject luminance of the image data, and then white balance of the image data is adjusted on the basis of the determined condition of a light source and color information of a pixel in the image data.

In other words, white balance of image data is adjusted on the basis of a condition of a light source which has been determined on the basis of subject luminance. Thereby, white balance of image data is adjusted under a condition of a light source which is suitable for a subject. Consequently, it is possible to improve color reproducibility of an image on the basis of a photographed image.

Meanwhile, it is possible to perform the above white balance adjustment in a computer (including an image output apparatus) which has obtained image data generated in an image input apparatus, or in the image input apparatus itself.

The image data on the basis of a photographed image includes image data which is generated by demosaicking raw image data, image data which is generated by correcting the image data through γ (gamma) correction, the raw image data itself.

In the case of obtaining image data, a raw image file having imaging condition information representing an imaging condition may be obtained, and the image data may be obtained on the basis of the raw image file.

The condition of a light source in imaging includes a condition for classifying types of a plurality of light sources and types of individual light sources. Obviously, a condition of a light source to be determined may be two types or may be three types or more.

The adjustments of white balance on the basis of color information of a pixel in image data include an adjustment on the basis of color information (including averaged color information) which is generated by integrating color information of a pixel in every area into which an image is divided, an adjustment on the basis of color information which is generated by integrating color information of a pixel in every segment which is segmented in accordance with brightness such as luminance, and an adjustment on the basis of color information in every pixel.

It is preferable that white balance be adjusted such that a color resulting from the image data and according to the determined condition of a light source is converted into an achromatic color. Thereby, color reproducibility of an image is further improved. The colors resulting from image data include a color represented by color information which is generated by integrating color information in an area or a segment selected in accordance with a condition of a light source, and a color represented by color information which is generated by integrating color information of a plurality of pixels selected in accordance with a condition of a light source.

A condition of a light source in imaging may be determined as an outdoor light source in the case where the subject luminance is relatively high, whereas a condition of a light source in imaging may be determined as an indoor light source in the case where the subject luminance is relatively low. In the case where the determined condition of a light source is an indoor light source, a color to be converted into an achromatic color may be selected from colors including a more bluish color with respect to the case that the condition is determined as an outdoor light source. Consequently, color reproducibility of an image is further improved.

Further, it is preferable that white balance be adjusted such that the color resulting from the image data which is included in a white balance determination range is converted into an achromatic color. Consequently, color reproducibility of the image is further improved.

It is possible to apply the above aspects of the invention: to a white balance processing apparatus including a image data obtaining unit, a light source condition determination unit, and a white balance adjustment unit; to a system including the apparatus; to a method for processing white balance including a process for obtaining image data, a process for determining a condition of a light source, and a process for adjusting white balance; to a white balance processing program for executing a function for obtaining image data, a function for determining a condition of a light source, and a function for adjusting white balance; and to a medium recording the program and being readable in a computer.

### BRIEF DESCRIPTION OF THE DRAWINGS

The invention will be described with reference to the accompanying drawings, wherein like numbers reference like elements.

FIG. 1 is a block diagram schematically illustrating the configuration of a white balance processing apparatus according to a first embodiment of the invention.

FIG. 2 is a block diagram illustrating a computer system including a white balance processing apparatus.

FIG. 3A is a diagram schematically illustrating a constitution of a RAW image file.

FIG. 3B is a diagram schematically illustrating a constitution of image data.

FIG. 4 is a graph illustrating a white balance determination range.

FIG. 5 is a diagram schematically illustrating extraction of an area for determining white balance.

FIG. 6 is a flowchart illustrating white balance processing.

FIG. 7 is a flowchart illustrating white balance processing in accordance with a second embodiment of the invention.

FIG. 8 is a flowchart illustrating white balance processing in accordance with a third embodiment of the invention.

FIG. 9A is a graph illustrating a white balance determination range in accordance with the third embodiment.

FIG. 9B is a graph illustrating another white balance determination range in accordance with the third embodiment.

### DESCRIPTION OF EXEMPLARY EMBODIMENTS

### First Embodiment

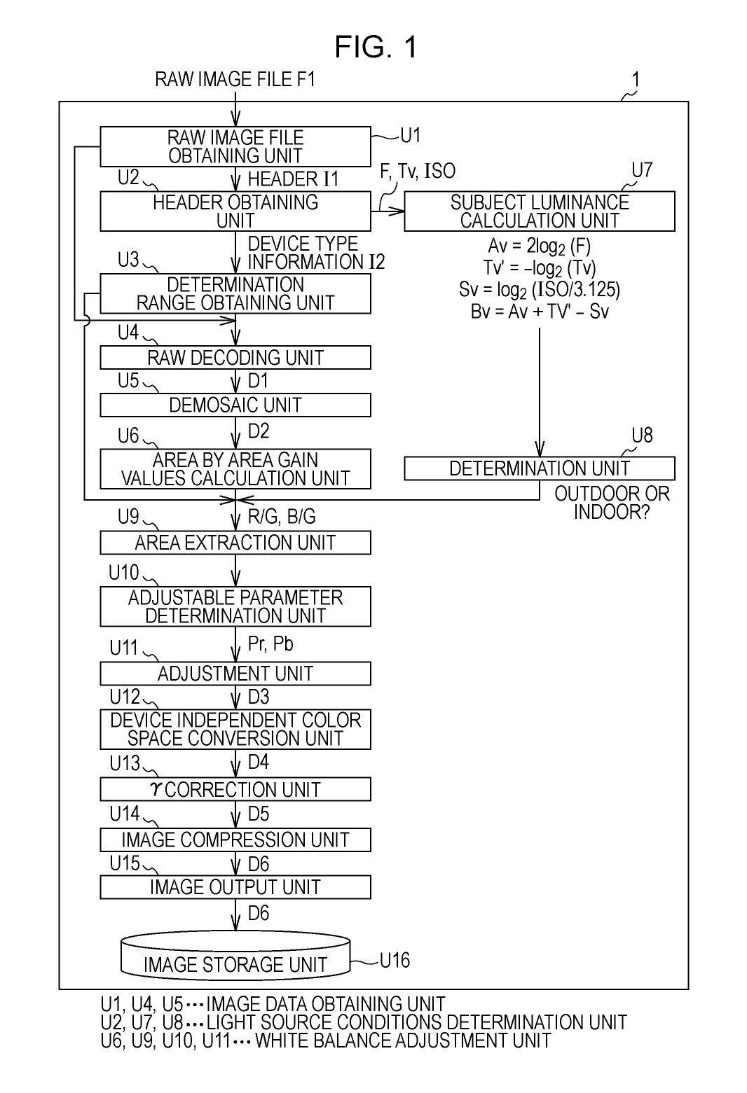

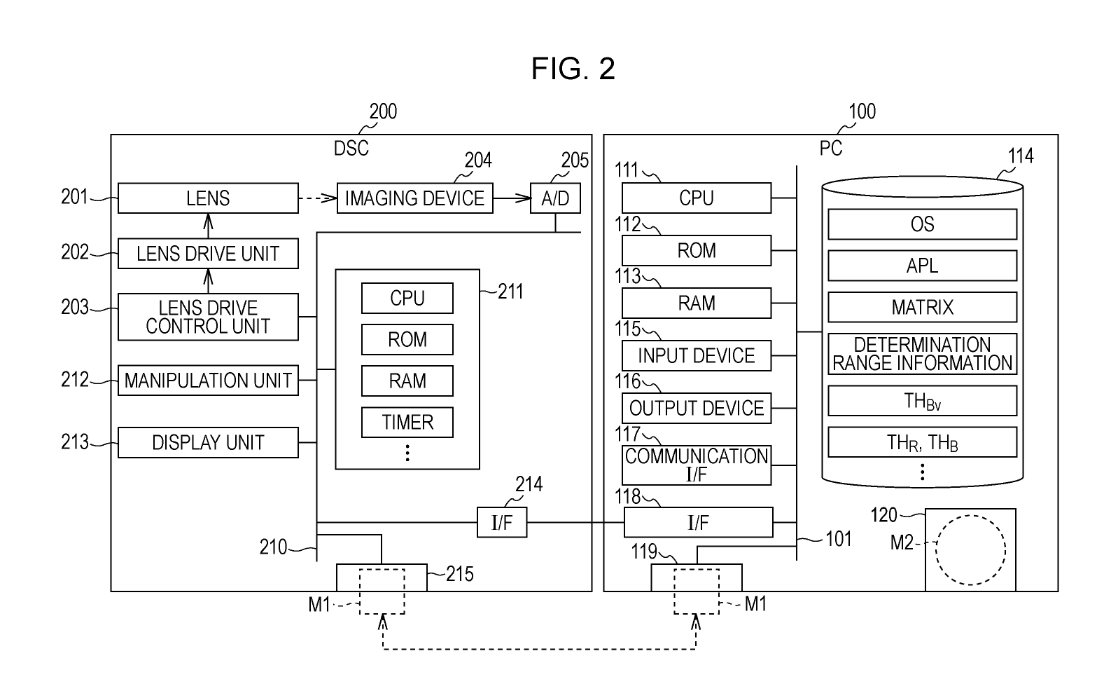

With reference to FIG. 1, a white balance processing apparatus 1 according to a first embodiment of the invention includes units U1 to U16. In the white balance processing apparatus 1, a RAW image file (an original image file) F1 is obtained to develop RAW image data (original image data) D1, and then image data D6 in which white balance is adjusted is generated. For example, a computer system shown in FIG. 2 is provided with the white balance processing apparatus 1.

The computer system shown in FIG. 2 includes a personal computer (PC) 100 as an image processing apparatus and a digital still camera (DSC) 200 as an image input apparatus. The white balance processing apparatus 1 of the embodiment is the PC 100, and a method for processing white balance of the embodiment is performed in the PC 100. Obviously, the white balance processing apparatus of the invention may be a DSC, may be included in both of the PC and DSC, or may be a PC and DSC system cooperating with each other. The image processing apparatus used may include an image output apparatus such as a printer and a display apparatus or may include a plurality of computers connected to each other via a network. The image input apparatus used may include a video camera. The computer system used may include an apparatus in which an image processing apparatus is integrated with an image input apparatus.

In the PC 100, a central processing unit (CPU) 111, a semiconductor memory device as a read only memory (ROM) 112, a semiconductor memory device as a random access memory (RAM) 113, a memory device 114, an input device 115, an output device 116, a communication interface (I/F) 117, an I/F 118, a card I/F 119, a disk drive 120, and the like are connected to a bus 101, through which these components can input and output information each other. The CPU 111 controls the entire operation of the PC 100 in accordance with a program stored in the ROM 112 while using the RAM 113 as a working area.

An operating system (OS), an application program (APL), a color conversion matrix, information representing a white balance determination range R1, and thresholds TH_{Bv}, TH_{R}, and TH_{B} are stored in the memory device 114. It is possible to use a hard disk (magnetic disk) and a nonvolatile semiconductor memory as memory included in the memory device 114.

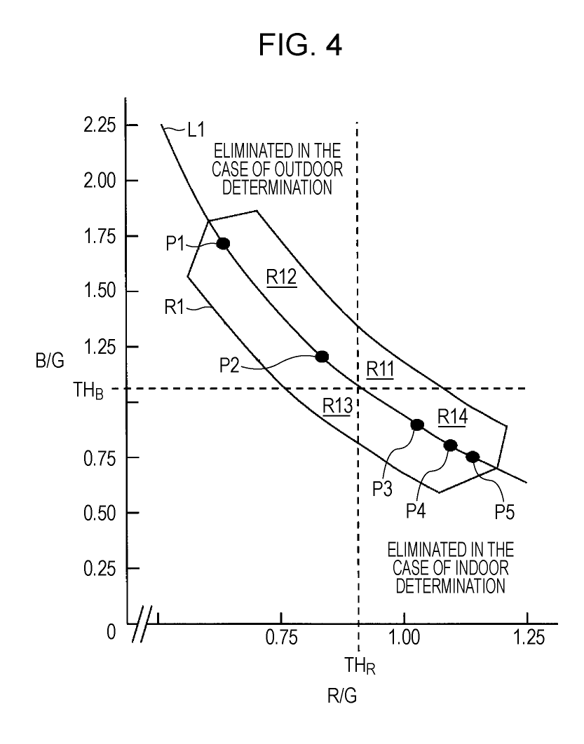

The APL of the embodiment includes a white balance processing program of which some portions correspond to units U1 to U15 in the white balance processing apparatus 1. Obviously, the OS may include the white balance processing program. The color conversion matrix includes information for converting between a device independent RGB color space and a device dependent RGB color space depending on types of an imaging device. The information representing the white balance determination range R1 indicates a space for determining whether color information in every area into which an image has divided is used for a white balance adjustment or not. The white balance determination range R1 is an area along a black body radiation locus L1 including a color temperature in the range of 2800 K to 8000 K on a R/G-B/G plane of the device dependent RGB color space as shown in FIG. 4. The TH_{Bv} is a threshold for determining a condition of a light source in imaging and is a threshold with respect to subject luminance Bv corresponding to a photographed image. The TH_{R} and TH_{B} are thresholds for extracting an area for performing determination using the white balance determination range R1 in accordance with the determined condition of a light source, and are thresholds with respect to color information of the area.

It is possible to configure the input device 115 with an operation input device such as a keyboard and a mouse (a pointing device). It is possible to configure the output device 116 with an image output device such as a display device and a printer. The communication I/F 117 is an interface for connecting the PC 100 to a network. The I/F 118 is an interface for inputting and outputting information to the image input device and is connected to an I/F 214 of the DSC 200. It is possible to removably insert a memory card M1 using a nonvolatile semiconductor memory into the slot of the card I/F 119. It is possible to removably insert a recording medium such as a compact disk-read only memory (CD-ROM) which is readable in a computer into the disk drive 120. The white balance processing program may be installed on the PC 100 from the recording medium M2 recording the program or may be downloaded from a server computer through a network to the memory device 114.

The DSC 200 includes units 201 to 205 of an optical system and units 211 to 215 of a control system.

The units of the optical system include a lens drive unit 202 for driving a lens 201 to control a position of a focal point (focus) and focal length, a lens drive control unit 203 for controlling the operation of the lens drive unit 202, an imaging device 204 for converting light input to an acceptance surface through the lens 201 into an analog electric signal, and an analog/digital (A/D) conversion circuit 205 for converting an analog signal output from the imaging device 204 into a digital signal. The imaging device 204 is configured with a single plate type charge coupled device (CCD), for example. In this case, the imaging device 204 is provided with a color filter on which a single color among predetermined component colors (R, G, and B, for example) is disposed in every pixel, on the side of the light receiving surface thereof.

The units 211 to 215 of a control system, the lens drive control unit 203, and the A/D conversion circuit 205 are connected to a bus 210, and it is possible through the bus 210 to input and output information each other. A controller 211 includes a CPU, ROM, RAM, and a timer and controls the entire operation of the DSC 200 in accordance with a program stored in the ROM while using the RAM as a working area. It is possible to configure a manipulation unit 212 with a plurality of switches such as push-button switches. It is possible to configure a display 213 with a liquid crystal display, light emitting diodes and the like. An I/F 214 is an interface for inputting and outputting information to the image processing apparatus. It is possible to removably insert the memory card M1 into the slot of a card I/F 215.

The above hardware and software cooperate with each other to build the white balance processing apparatus 1 shown in FIG. 1. In the white balance processing apparatus 1 of the embodiment, programs corresponding to U1 to U5 and U11 to U13 configure a module for developing a RAW image, and programs corresponding to U6 to U10, U14, and U15 configure a single automatic correction module. Units of the white balance processing apparatus 1 will be described below.

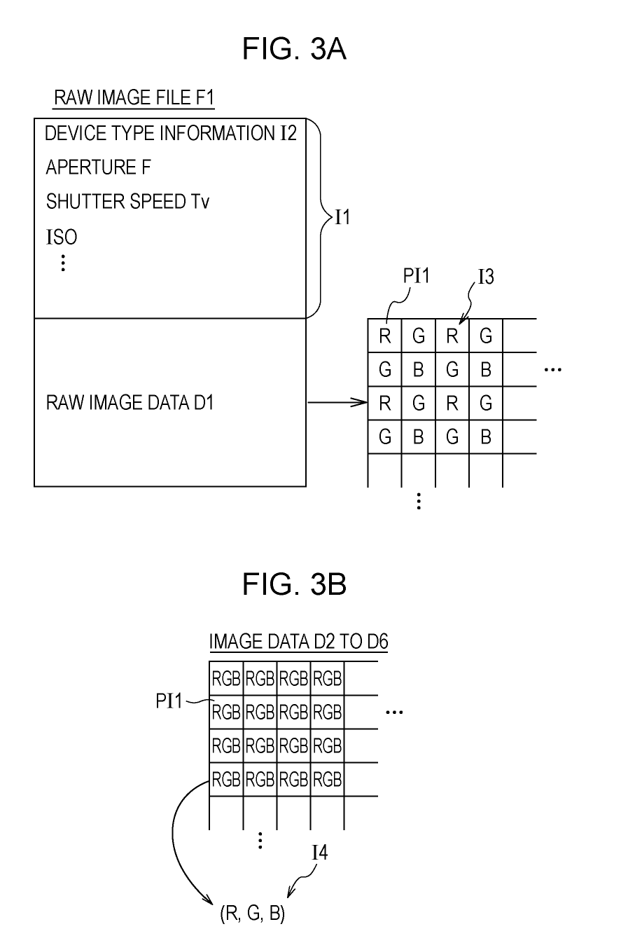

A RAW image file obtaining unit U1 obtains a RAW image file F1 shown in FIG. 3A. The RAW image file F1 of the embodiment has a data structure in which header information I1 (imaging condition information) representing imaging conditions is attached to RAW image data D1 on the basis of a photographed image. The RAW image data D1 is bayer data having color information I3 of any one of the colors of R, G, and B as a gradation value for every pixel PI1. The header information I1 has information representing imaging conditions such as device type information I2 representing a type of an imaging device, an aperture F number, shutter speed Tv, and ISO speed. It is possible to use a file having a format in accordance with the exchangeable image file format (Exif) of version 2.2 for the RAW image file F1. The Exif is a registered trademark of Japan Electronics and Information Technology Industries Association in Japan.

A header obtaining unit U2 obtains the header information I1 including the device type information I2 from the RAW image file F1. Thereby, a type of an imaging device with respect to a photographed image is specified from the header information I1. A determination range obtaining unit U3 obtains information representing a white balance determination area in an RGB color space (a predetermined color space) in accordance with the device type information I2, the information representing a white balance determination area being for determining the white balance of the image data D2 on the basis of the RAW image file F1. FIG. 4 illustrates the white balance determination range R1 on an R/G-B/G plane of a device dependent RGB color space. The R/G is a ratio of an R component with respect to a G component in an RGB color space, and the B/G is a ratio of a B component with respect to a G component in the RGB color space. The information representing the white balance determination range is allowed to be indicated by a set of coordinates which represent a plurality of points discretely located in the white balance determination range on an R/G-B/G plane, and indicated by a set of a plurality of coordinates which represent a boundary portion of the white balance determination range on an R/G-B/G plane. The information representing a white balance determination range is prepared in every type of an imaging device and is stored in the memory device 114 in accordance with the device type information, for example. Obviously, information representing a former white balance determination range on the basis of a black body radiation locus on coordinates, such as uniform color space (UCS) chromaticity coordinates defined by International Commission on Illumination (CIE), may be stored in the memory device 114. In this case, the information representing the former white balance determination range is converted into a color space according to a type of an imaging device, so that it is possible to obtain the information representing a white balance determination range. The determination range obtaining unit U3 of the embodiment selects information corresponding to the device type information I2 from a plurality of information representing a white balance determination range depending on types of a device.

A RAW decoding unit U4 decodes the RAW image file F1 to obtain the RAW image data D1. A demosaic unit U5 performs demosaic processing to each of the pixels PI1 of the RAW image data D1 to complement color information, and the image data D2 having color information I4 of colors R, G, and B as gradation values is generated in every pixel PI1 as shown FIG. 3B. The image data D2 is image data represented in a device dependent RGB color space and based on a photographed image and is image data which is an object of a white balance adjustment. In the embodiment, the units U1, U4, and U5 constitute the image data obtaining unit and correspond to a process for obtaining image data and a function for obtaining image data.

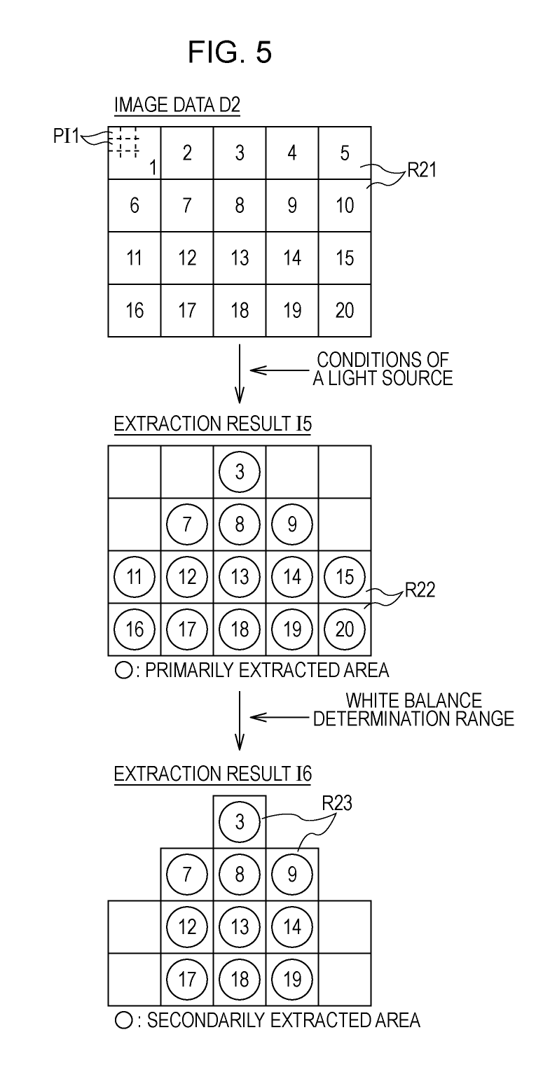

In the case where the image data D2 is divided into areas R21 of an image as shown in FIG. 5, an area by area gain values calculation unit U6 calculates gain values R/G and B/G of white balance in every area R21. Although the gain values R/G and B/G of the embodiment are arithmetic mean values of gain values R/G and B/G of each of pixels PI1 in each of the areas R21, it may be summations or geometric mean values of the gain values R/G and B/G. The gain values R/G and B/G are information in every area R21 on the basis of color information I4 of a pixel in the image data D2.

A subject luminance calculation unit U7 calculates subject luminance Bv of the image data D2 which is an object of a white balance adjustment by using the aperture F number, the shutter speed Tv, and the ISO speed included in the header information I1. In the case of:

Av=2 log2(F) (1);

Tv′=log2(Tv) (2); and

Sv=log2(ISO/3.125) (3),

by virtue of the following relationship

AV=Tv′=Bv+Sv (4)

it is possible to calculate the subject luminance Bv by the following formula

Bv=Av+Tv′−Sv=2 log2(F)−log2(Tv)−log2(ISO/3.125) (5).

A determination unit U8 determines a condition of a light source in imaging on the basis of the subject luminance Bv of image data. In the case of high subject luminance, a light source in imaging is generally an outdoor light source such as sunlight (a color temperature of approximately 5200 K to 5500 K), shade (a color temperature of approximately 7500 K to 8000 K), and a cloudy day (a color temperature of approximately 6500 K). In the case of low subject luminance, a light source in imaging is generally an indoor light source such as tungsten (a color temperature of approximately 2800 K) and a fluorescent light (a color temperature of approximately 3800 K to 4500 K). In the determination unit U8 of the embodiment, subject luminance Bv is compared with a threshold TH_{Bv}. In the case of relatively high subject luminance Bv, it is determined that a light source in imaging is an outdoor light source, whereas, in the case of relatively low subject luminance Bv, it is determined that a light source in imaging is an indoor light source. The threshold TH_{Bv} is set so as to be between luminance of an outdoor light source and luminance of an indoor light source.

In the embodiment, each of the units U2, U7, and U8 configures a light source condition determination unit and corresponds to a process for determining a light source condition and a function for determining a light source condition.

In the case where a light source in imaging is specified without using the subject luminance, tungsten and a fluorescent light as a light source in imaging may be faultily determined as a light source such as sunlight, shade, and a cloudy day, and sunlight and shade as a light source in imaging may be faultily determined as a light source such as tungsten and a fluorescent light, depending on the color of the subject. For this reason, white balance of image data is adjusted under a light source condition different from a condition in which imaging has been performed.

In the invention, because a condition of a light source is determined on the basis of subject luminance, such wrong determination hardly occurs, and white balance of image data is adjusted under a condition of a light source suitable for a subject.

An area extraction unit U9 extracts an area to be used in the white balance adjustment from a plurality of areas R21 in the image.

FIG. 5 schematically shows extraction of an area R23 used for white balance adjustment from image data D2. In an upper portion in FIG. 5, each of the areas R21 is assigned a serial number i (1 to 20). In the area extraction unit U9 of the embodiment, an area R22 used for white balance adjustment is primarily extracted on the basis of a determined condition of a light source and gain values R/G and B/G in every area R21. In order to indicate an extraction result I5 shown in a middle portion in FIG. 5, extracted areas R22 are individually circled. Then, in the area extraction unit U9, an area R23 is extracted from the areas R22 among which gain values R/G and B/G are included in the white balance determination range R1. In order to indicate an extraction result I6 shown in a lower portion in FIG. 5, extracted areas R23 are individually circled.

In FIG. 4, the coordinates P1 to P5 for each of the above light sources are shown on the black body radiation locus L1 on the R/G-B/G plane in a device dependent RGB color space. As shown in FIG. 4, a coordinate P1 of tungsten and a coordinate P2 of a fluorescent light have higher B/G than a coordinate P3 of sunlight, a coordinate P4 of a cloudy day, and a coordinate P5 of shade, the tungsten and fluorescent light being an indoor light source, and the sunlight, cloudy day, and shade being an outdoor light source. In other words, the coordinates P1 and P2 is bluish relative to the coordinates P3, P4, and P5. In the area extraction unit U9 of the embodiment, each of the gain values R/G and B/G is compared with thresholds TH_{R} and TH_{B}, respectively. In the case where it is determined as an outdoor light source, the area R22 having R/G equal to or greater than TH_{R} or having B/G equal to or less than TH_{B} is primarily extracted, whereas, in the case where it is determined as an indoor light source, the area R22 having R/G equal to or less than TH_{R} or having B/G equal to or greater than TH_{B} is primarily extracted. By virtue of this advantage, in the white balance determination range R1 on the R/G-B/G plane, the bluish range R12 is not used for a white balance adjustment in the case of an outdoor light source, and a reddish range R14 is not used for a white balance adjustment in the case of an indoor light source. The thresholds TH_{R} and TH_{B} are set so as to be values between each of the gain values of an outdoor light source and each of the gain values of indoor light source as shown in FIG. 4.

It is possible to divide the white balance determination range R1 used for a white balance adjustment by lines passing through coordinates (TH_{R} and TH_{B}). However, because the white balance determination range R1 is a narrow area along the black body radiation locus L1, areas R11 and R13 are small. Accordingly, even though the areas R11 and R13 are used in both of the cases where it is determined as an outdoor determination and where it is determined as an indoor determination, the quantity of white balance processing hardly increases. Just comparing the gain values R/G and B/G with the thresholds TH_{R} and TH_{B} respectively, the quantity of the white balance processing is rather reduced.

An adjustable parameter determination unit U10 determines adjustable parameters Pr and Pb to be used for a white balance adjustment on the basis of gain values R/G and B/G in the secondarily extracted area R23. The adjustable parameters Pr and Pb are an arithmetic average value or the like of the gain values R/G and B/G in the area R23. Accordingly, the adjustable parameters Pr and Pb represent a color according to a condition which results from the image data D2 and which is determined in the determination unit U8. In addition, in the case where the area R23 is not secondarily extracted, the adjustable parameters are set so as to be Pr=Pb=1 such that a white balance adjustment is not performed.

An adjustment unit U11 adjusts white balance of the image data D2 on the basis of the adjustable parameters Pr and Pb. In other words, white balance is adjusted on the basis of a determined condition of a light source and the color information I4 of a pixel in the image data D2. In the adjustment unit U11 of the embodiment, white balance of the image data D2 is adjusted such that the color represented by the adjustable parameters Pr and Pb is converted into an achromatic color.

In the embodiment, the units U6, and U9 to U11 configure a white balance adjustment unit and correspond to a process for adjusting white balance and a function for adjusting the white balance.

A device independent color space conversion unit U12 converts image data D3 which is generated by the white balance adjustment from an RGB color space depending on types of an imaging device into a device independent RGB color space such as the sRGB color space. A γ correction unit U13 performs γ correction to image data D4 which is generated by the color space conversion such that the data D4 has a gradation having appropriate brightness under output characteristics of an image output apparatus. An image compression unit U14 compresses image data D5 which is generated by the γ correction into a predetermined image format such as a joint photographic experts group (JPEG) format. In an image output unit U15, image data D6 which is generated by the compression is stored in an image storage unit U16 and output to an image output apparatus. The image storage unit U16 corresponds to the memory device 114, the recording mediums M1 and M2, a server computer and the like.

Meanwhile, it is possible to consider that each of the image data D1 to D6 is image data on the basis of a photographed image. Accordingly, the white balance adjustment of the invention may be applied to any one of the RAW image data D1, image data which has undergone the conversion into a device independent color space, image data which has undergone the γ correction, and compressed image data.

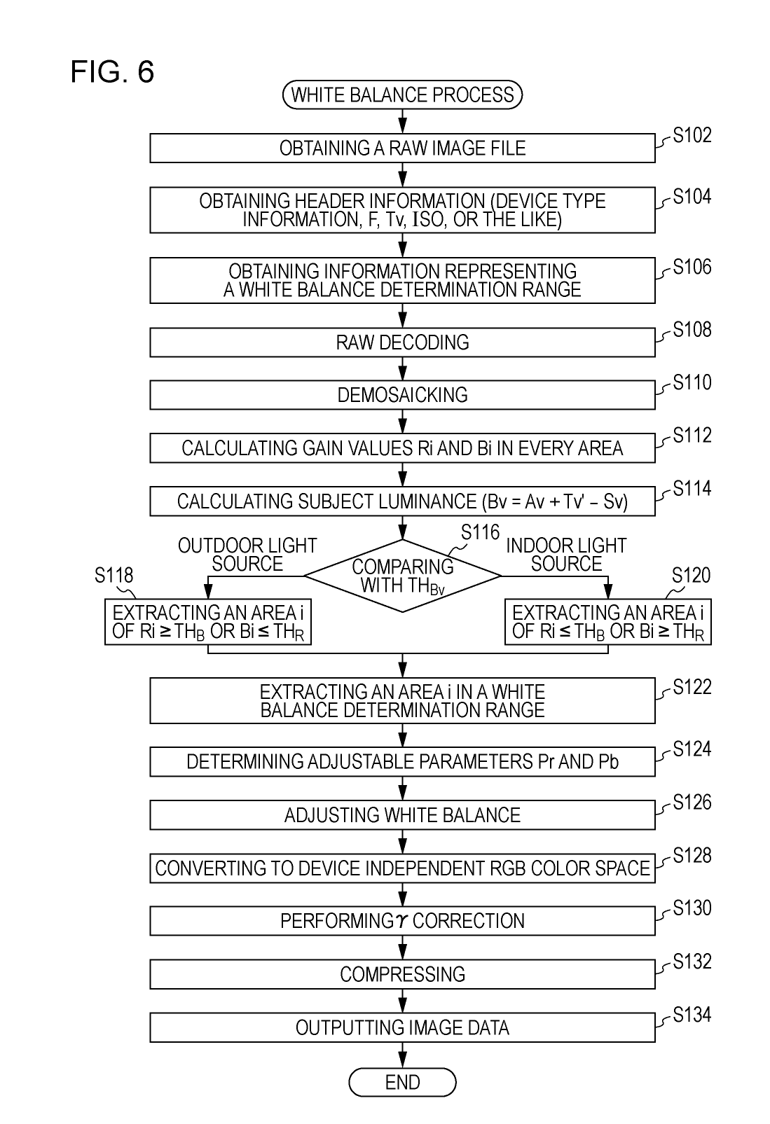

FIG. 6 illustrates a white balance process performed with the CPU 111 of the PC 100. The process shown in FIG. 6 is performed when a white balance processing program is running in the presence of an OS. Operation, effects, and advantages of the white balance processing apparatus 1 will be described below.

Once the process shown in FIG. 6 starts, the RAW image file F1 is obtained from, for example, the memory card M1 connected to the card I/F 119 (process S102, the description of “process” will be omitted hereinafter). Needless to say, the RAW image file may be obtained from the memory device 114, the recording medium M2, a server computer, or the like. In S104, the header information I1 including the device type information I2, an aperture F number, shutter speed Tv, and ISO speed is obtained from the RAW image file F1. In S106, information representing the white balance determination range R1 according to types of a device is obtained from the memory device 114 or the like on the basis of the device type information I2.

In S108, the RAW image file F1 is decoded to obtain the RAW image data D1. In S110, the RAW image data D1 is demosaicked to obtain the image data D2 having the color information I4 of R, G, and B in every pixel PI1. In S112, as shown in FIG. 5, gain values R/G and B/G are calculated in every area R21 into which the image data D2 is divided. In the embodiment, a gain value R/G in an area i is an arithmetic average value of gain values R/G of each pixel PI1 in the area i generated by the division of image data D2 (referred to as “Ri” hereinafter), and a gain value B/G in the area i is an arithmetic average value of gain values B/G of each pixel PI1 in the area i (referred to as “Bi” hereinafter).

In S114, the subject luminance Bv is calculated from an aperture F number, the shutter speed Tv, and ISO speed in accordance with the above described formula (5). In S116, the subject luminance Bv is compared with the threshold TH_{BV} to determine a condition of a light source in imaging.

In the case of Bᵥ≧TH_{Bv} (or Bv>TH_{Bv}), subject luminance is relatively high, so that it will be determined that a condition of a light source in imaging is an outdoor light source. In this case, in S118, the area R22 of Ri≧TH_{R} or Bi≦TH_{B}, for example, is primarily extracted from among the area R21. On the other hand, in the case of Bv<TH_{Bv} (or Bv≦TH_{Bv}), subject luminance is relatively low, so that it will be determined that a condition of a light source in imaging is an indoor light source. In this case, in S120, the area R22 of Ri≦TH_{R} or Bi≧TH_{B}, for example, is primarily extracted from among the area R21.

As a result, in the case where the determined condition of a light source is an outdoor light source, a color to be converted into an achromatic color is selected from colors including a more reddish color with respect to the case of an indoor light source. Meanwhile, in the case where the determined condition of a light source is an indoor light source, a color to be converted into an achromatic color is selected from colors including a more bluish color with respect to the case of an outdoor light source.

In S122, the area R23 is secondarily extracted from the primarily extracted area R22 among which gain values Ri and Bi are included in the white balance determination range R1.

In the case where the area R22 is not primarily extracted, for example, although it is determined as an outdoor light source, a color of a bluish range R12 including tungsten (P1 in FIG. 4) or a fluorescent light (P2 in FIG. 4) as an indoor light source will be used for white balance adjustment. Because white balance is adjusted on the basis of the color of the bluish range R12 which is not suitable for the outdoor light source, the color reproducibility of an image on the basis of a photographed image may be insufficient. The same incident will take place in the case where it is determined as an indoor light source.

In the white balance processing apparatus 1, in the case where it is determined as an outdoor light source, the bluish range R12 being inappropriate is eliminated, and in the case where it is determined as an indoor light source, the reddish range R14 being inappropriate is eliminated.

In the case where the area R23 is secondarily extracted, in S124, the secondarily extracted gain values Ri and Bi in the area R23 is averaged to obtain the adjustable parameters Pr and Pb. In the case where the area R23 is not secondarily extracted, the adjustable parameter is set so as to be Pr=Pb=1 for example. In S126, the white balance of the image data D2 is adjusted such that a color represented by the adjustable parameters Pr and Pb is converted into an achromatic color, that is, coordinates, in which each color component R, G, and B of a color is represented by Pr×G, G, and Pb×G respectively, are converted into coordinates G, G, and G in the entire image. For example, in the case where an arithmetic average of each color component R, G, and B of the image data D2 is Ar, Ag, and Ab respectively, the image data D2 may be adjusted such that an arithmetic average of each color component R, G, and B of the image data D3 will be Ar/Pr, Ag, and Ab/Pb respectively after the white balance adjustment. It is possible for conversion of each color component R, G, and B in every pixel PI1 to employ a conversion method in which color components R and B are simply multiplied by 1/Pr and 1/Pb respectively, y conversion of coefficients according to the adjustable parameters Pr and Pb with respect to color components R, G, and B, and the like.

By virtue of the above processing, white balance is adjusted such that a color, which results from the image data D2 and is included in a portion corresponding to the determined condition of a light source in the white balance determination range R1, is converted into an achromatic color.

In addition, in S126, exposure may be adjusted.

In S128, the image data D3 of an RGB color space depending on the type of a device is converted into a device independent RGB color space. Consequently, it is possible to generate image data of which white balance has been adjusted in accordance with the type of an imaging device, making the generated image data be in the device independent RGB color space. In S130, γ correction is performed to the image data D4 which has been generated by the conversion. In S132, the image data D5 generated by the γ correction is compressed into a predetermined format. In S134, the image data D6 generated by the compression is stored in the memory device 114 and is output to an image output apparatus by the PC 100, and then the process finishes.

As described above, white balance of image data according to a photographed image is adjusted on the basis of a condition of a light source, the condition being determined on the basis of subject luminance Bv. Consequently, the white balance of the image data D2 is adjusted under a condition of a light source suitable for a subject. As a result, it is possible to improve color reproducibility of an image on the basis of a photographed image by the white balance processing apparatus 1, the method for processing white balance, and the program for processing white balance according to the embodiment.

### Second Embodiment

It is possible to arbitrarily change the sequence of each of the above described processes of the white balance processing. For example, decoding in S108 and demosaicking in S110 may be performed between S102 and S106. The calculation of subject luminance in S114 may be performed between S104 and S112. Furthermore, an area in which gain values R/G and B/G are within the white balance determination range R1 may be primarily extracted from the area R21, into which the image data D2 is divided, and then an area according to a determined condition of a light source may be secondarily extracted from the primarily extracted area.

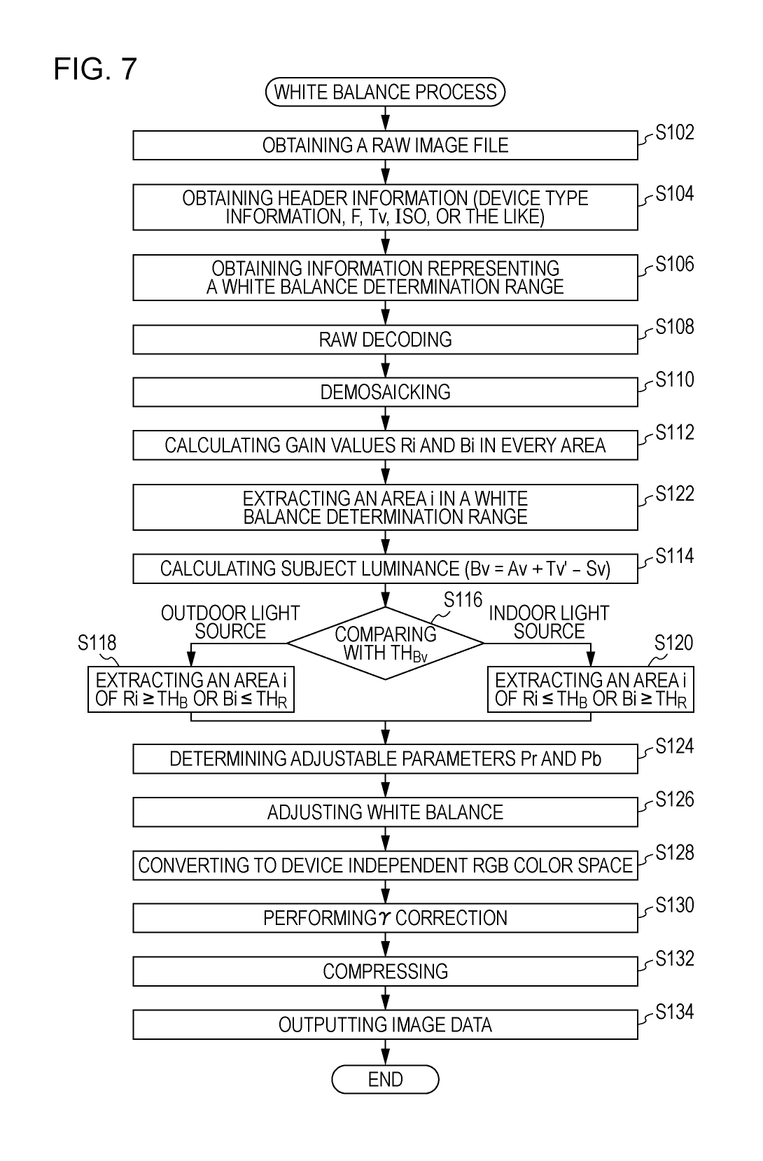

FIG. 7 illustrates a white balance process which is performed by a white balance processing apparatus according to a second embodiment of the invention. The block configuration of the white balance processing apparatus according to the second embodiment is allowed to be the same as that of the first embodiment. In addition, processing S102 to S112 and S124 to S134 of the embodiment is allowed to be the same as that of the first embodiment.

In the embodiment, after S112 has finished, an area i in which gain values Ri and Bi are within the white balance determination range R1 is primarily extracted from each of the areas R21 of the image data (S122). Then, subject luminance Bv is calculated (S114), and the resultant is compared with the threshold TH_{Bv} (S116). Subsequently, an area such as Ri≧TH_{R} or Bi≦TH_{B} is secondarily extracted from the area i in the case where it is determined as an outdoor light source (S118), while an area such as Ri≦TH_{R} or Bi≧TH_{B} is secondarily extracted from the area i in the case where it is determined as an indoor light source (S120). The area to be secondarily extracted is the same as the area R23 in the first embodiment. By virtue of the embodiment also, it is possible to take advantage that color reproducibility of an image is improved on the basis of a photographed image.

### Third embodiment

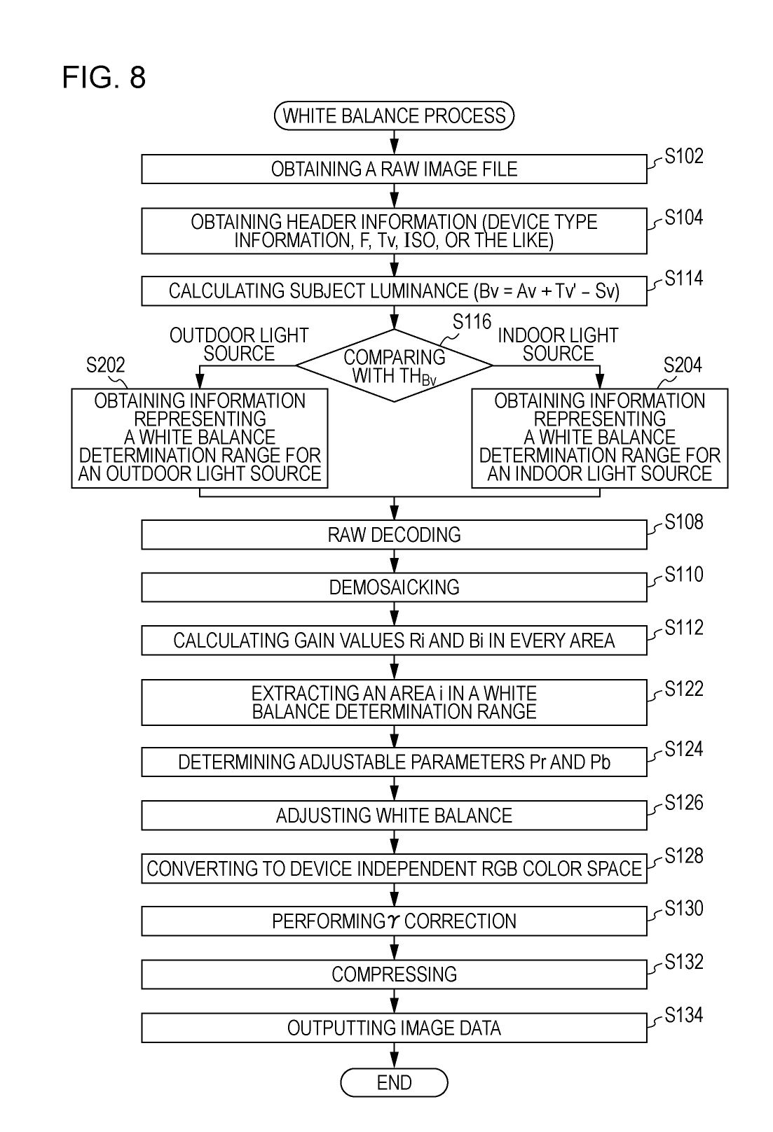

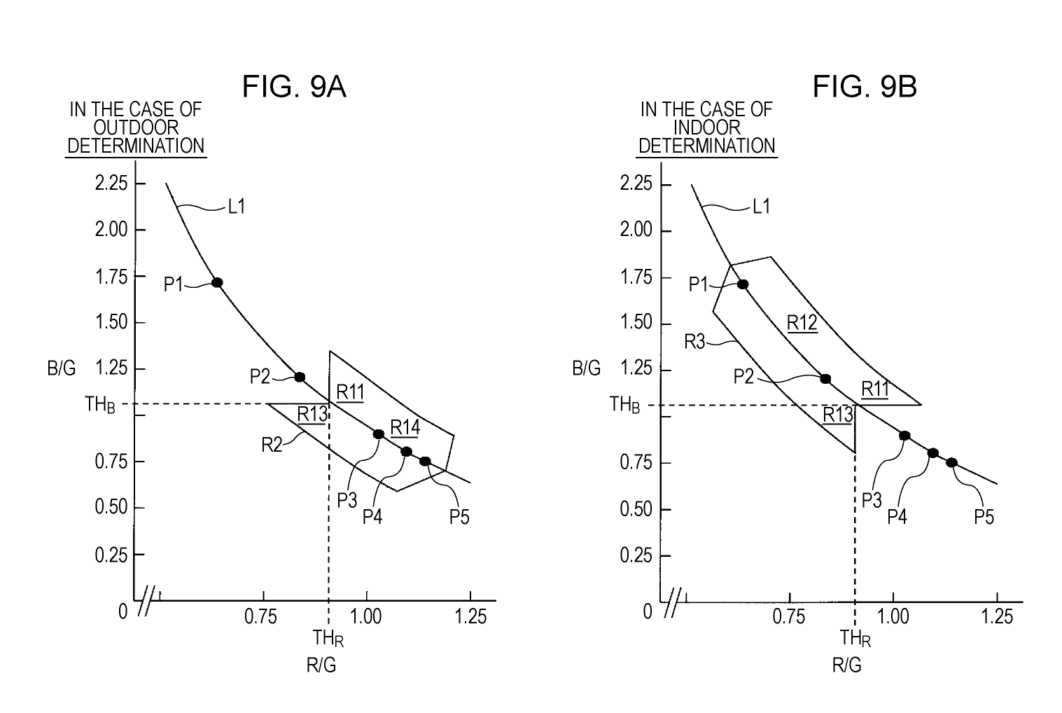

FIGS. 8 and 9 illustrate a third embodiment of the invention in which an area of an image in which a gain value is used for white balance adjustment is extracted at a time. In the embodiment, as shown in FIG. 9, a white balance determination range R2 and a white balance determination range R3 are prepared per type of an imaging device, the white balance determination range R2 being used when it is determined as an outdoor light source, and the white balance determination range R3 being used when it is determined as an indoor light source. The white balance determination range R2 for an outdoor light source is an area such that the bluish range R12 is excluded from the white balance determination range R1 in the first embodiment. The white balance determination range R3 for an indoor light source is an area such that the reddish range R14 is excluded from the white balance determination range R1 in the first embodiment. Shapes of the white balance determination ranges R2 and R3 in accordance with conditions of a light source are obviously an example. Other shapes may be prepared such that they do not overlap each other.

In the white balance process shown in FIG. 8, the subject luminance Bv is calculated after S104 has finished (S114). Then, the subject luminance Bv is compared with the threshold TH_{Bv} (S116). Subsequently, in the case where it is determined as an outdoor light source, information representing the white balance determination range R2 for an outdoor light source is obtained from the memory device 114 on the basis of the device type information 12 (S202), and in the case where it is determined as an indoor light source, information representing the white balance determination range R3 for an indoor light source is obtained from the memory device 114 on the basis of the device type information I2 (S204). Then, decoding, demosaicking, and calculating gain values Ri and Bi in every area i are performed (S108 to S112), and then an area in which the gain values Ri and Bi are within a white balance determination range (R2 or R3) according to conditions is extracted (S122). The area to be extracted is the same as the area R23 in the first embodiment. Accordingly, in S124 to S126, white balance is adjusted such that a color of the image data D2 included in a white balance determination range according to a specified condition of a light source is converted into an achromatic color.

According to the embodiment, it is possible to take an advantage that color reproducibility of an image on the basis of a photographed image is improved and to increase the speed of white balance adjustment.

### Other Modifications

It is possible to variously modify the white balance processing apparatus of the invention. For example, each of the units of a white balance apparatus may be partially or entirely configured with hardware such as an application specific integrated circuit (ASIC).

Imaging condition information representing imaging conditions may be not only header information but footer information of an original image file.

The white balance adjustment of image data may be performed not only in a device dependent RGB color space, but in a device independent RGB color space, the CMY (cyan, magenta, yellow) color space, the YUV color space, the HSB color space, the Yxy color space, the CIE XYZ color space, the CIE L*u*v* color space, and the CIE L*a*b* color space.

A white balance determination range may be an area in which the range is changed in accordance with brightness such as luminance.

The calculation of gain values in S112, in which it is determined whether the gain values are included in a white balance determination range or not, may be performed in every segment into which an image is divided in accordance with the brightness of each of pixels of the image. For example, in S112, the luminance of each of pixels of image data may be obtained, and then each of the pixels of the image data may be disposed in descending order of the luminance, and then pixels may be divided into the equal number of segments in the disposed order, and then arithmetic average values of gain values R/G and B/G may be calculated for every segment.

A plurality of thresholds with respect to the subject luminance Bv may be prepared. For example, thresholds TH_{Bvout} and TH_{Bvin} which are set so as to be TH_{Bvout}>TH_{Bvin} may be prepared. In the case of Bv≧TH_{Bvout} in S116 in FIG. 6, subject luminance is relatively high, and it is determined that a condition of a light source is an outdoor light source, so that processing in S118 will be performed. In the case of Bv≦TH_{Bvin} in S116 in FIG. 6, subject luminance is relatively low, and it is determined that a condition of a light source is an indoor light source, so that processing in S120 will be performed. In the case of TH_{Bvin}<Bv<TH_{Bvout}, subject luminance is neither high nor low, it is determined that a condition of a light source is an intermediate condition, so that processing in S122 will be performed. A plurality of thresholds may be prepared in order to distinguish types of individual light sources, and then the types of the individual light sources may be determined as a condition of a light source in imaging.

In addition, the threshold with respect to subject luminance may be a threshold varying in accordance with a position of an area in the image and brightness of a segment into which the image has been divided in accordance with brightness.

Furthermore, the thresholds TH_{R} and TH_{B} for determining an area in a white balance determination range to be used may be a threshold varying in accordance with the brightness of an image.

Moreover, in the case where the header information I1 of an image includes information representing that the image has been taken in an indoor environment or an outdoor environment, a necessary area may be extracted in accordance with the information. However, because such information is not generally included, it may be determined in accordance with luminance whether an image has been taken in an indoor environment or an outdoor environment.

The invention is not limited to the above embodiments and modifications. The invention may include a configuration in which the configurations, disclosed in the above embodiments and modifications, are replaced or recombined with each other, and may also include a configuration in which the configurations, disclosed in the related art and the above embodiments and modifications, are replaced and recombined with each other.

What is claimed is:

1. A white balance processing apparatus comprising:
an image data obtaining unit for obtaining image data on the basis of a photographed image;
a light source condition determination unit for determining a condition of a light source in imaging as an outdoor light source in the case where subject luminance of the image data is relatively high, while determining a condition of a light source in imaging as an indoor light source in the case where the subject luminance of the image data is relatively low; and
a white balance adjustment unit for determining a color to be converted into an achromatic color on the basis of color information of a pixel in the image data to adjust white balance of the image data, the color to be converted being selected from colors including a more bluish color with respect to the case that the condition of the light source is determined as an outdoor light source in the case where the determined condition of the light source is an indoor light source.

2. The white balance processing apparatus according to claim 1, wherein the white balance adjustment unit adjusts the white balance of the image data such that a color resulting from the image data and according to the determined condition of the light source is converted into an achromatic color.

3. The white balance processing apparatus according to claim 1,
wherein the image data obtaining unit obtains an original image file having imaging condition information representing imaging conditions and obtains the image data on the basis of the original image file,
wherein the light source condition determination unit obtains the subject luminance from the imaging condition information and determines the condition of a light source in imaging on the basis of the subject luminance.

4. The white balance processing apparatus according to claim 1, wherein the white balance adjustment unit adjusts the white balance of the image data such that a color resulting from the image data is converted into an achromatic color in a predetermined color space, the color resulting from the image data being included in a portion in accordance with the determined condition of the light source within a white balance determination range for determining the white balance of the image data.

5. The white balance processing apparatus according to claim 1, wherein the white balance adjustment unit adjusts the white balance of the image data such that a color in the image data is converted into an achromatic color in a predetermined color space, the color in the image data being included in a white balance determination range for determining the white balance of the image data, and the white balance determination range being in accordance with the determined condition of the light source.

6. A method for processing white balance comprising:
obtaining image data on the basis of a photographed image;
determining a condition of a light source, the condition of the light source in imaging being determined as an outdoor light source in the case where subject luminance of the image data is relatively high, while the condition of the light source in imaging being determined as an indoor light source in the case where the subject luminance of the image data is relatively low; and
determining a color to be converted into an achromatic color on the basis of color information of a pixel in the image data to adjust white balance of the image data, the color to be converted being selected from colors including a more bluish color with respect to the case that the condition of the light source is determined as an outdoor light source in the case where the determined condition of the light source is an indoor light source.

7. A recording medium of a white balance processing program comprising allowing a computer to execute the following:
a function for obtaining image data on the basis of a photographed image;
a function for determining a condition of a light source, the condition of the light source in imaging being determined as an outdoor light source in the case where subject luminance of the image data is relatively high, while the condition of the light source in imaging being determined as an indoor light source in the case where the subject luminance of the image data is relatively low; and
a function for determining a color to be converted into an achromatic color on the basis of color information of a pixel in the image data to adjust white balance of the image data, the color to be converted being selected from colors including a more bluish color with respect to the case that the condition of the light source is determined as an outdoor light source in the case where the determined condition of the light source is an indoor light source.
